(19) United States
(12) Patent Application Publication
(10) Pub. No.: US 2005/0161394 A1
(43) Pub. Date: Jul. 28, 2005

(54) Freeze resistant water filter

(76) Inventors: Karl Fritze, Denmark Township, MN (US); Jaime L. Harris, Rosemount, MN (US)

Correspondence Address: CUNO INCORPORATED, 400 RESEARCH PARKWAY, P. O. BOX 1018, MERIDEN, CT, 06450-1018, US

(21) Appl. No.: 11/030,722

(22) Filed: Jan. 4, 2005

Related U.S. Application Data
(63) Continuation-in-part of application No. 10/377,022, filed on Feb. 28, 2003.
(60) Provisional application No. 60/427,770, filed on Nov. 20, 2002.

(51) Int. Cl. B01D 35/00

(52) U.S. Cl. 210/435; 210/443; 210/232

(57) ABSTRACT

A freeze resistant filter cartridge assembly and methods for fabrication include a filter cartridge including a filter housing and a filter media and having at least one component selected from a list of components consisting of: the filter housing being formed of an increased elasticity polyolefin polymer having elongation and glass transition properties that allow for stretching of the housing during a freezing event rather than rupturing; a sleeve having a volume of air entrapped therein within and being disposed in the interior of the filter cartridge; and the filter housing formed of a conventional polyolefin having a wall thickness great enough to resist freeze induced expansion stresses. A disassemble cartridge filter includes a filter cap, a filter housing and a filter element. The filter cap and filter housing are rotatably attached wherein cap and housing engagement members prevent rotatable disengagement of the filer cap and filter housing.

### PRIORITY CLAIM

The present application is a Continuation-In-Part application of U.S. patent application Ser. No. 10/377,022, filed Feb. 28, 2003 and entitled “FREEZE RESISTANT WATER FILTER”, which claims the benefit of U.S. Provisional Application No. 60/427,770, filed Nov. 20, 2002, both of which are herein incorporated by reference to the extent not inconsistent with the present disclosure.

### BACKGROUND OF THE DISCLOSURE

The present disclosure relates generally to the field of point-of-use water filtration products. More specifically, the present disclosure relates to a replaceable filter cartridge for use in a refrigerator, the filter cartridge constructed in manner that resists bursting when exposed to freezing conditions.

A common feature found in many of the refrigerators sold today is an internal water filtering system capable of supplying filtered water to either a drinking dispenser or to an icemaker. In most applications, these filter systems use a filter medium having the capacity to remove chlorine and particulate matter from the source water resulting in cleaner, better tasting water and ice.

When designing these filter systems, an important design consideration is the amount of space that the filter will occupy. This is because any space occupied by the filter will reduce available food storage space within the refrigerator. One way to reduce the space consumed by a water filter system is to use a replaceable cartridge filter. The replaceable cartridge filter typically has enough filtering capacity to last months at a time before it needs to be replaced by a fresh filter.

Previous refrigerator water system designs have included means to protect the water filter by integrating an isolation solenoid valve before the house connection and filter. This valve is only open while filtered water is called for and thus eliminates the potential for flooding in the event of a structural filter failure. In a effort to reduce system complexity and cost, refrigerator manufactures have sought to eliminate the isolation valve and run the filters at a continuous high pressure. One way of replacing the isolation solenoid valve has been to incorporate shut-off means within the filter system itself. One example of such shut-off means is a spring valve within a manifold that closes the water supply line when a filter cartridge is removed.

While the filter shut-off means are effective when a filter cartridge is removed from the system, these shut-off means are ineffective when an event causes a structural failure of the filter cartridge while it is still engaged with the manifold. If a refrigerator lacks the isolation valve, water will continue to flow into and out of the damaged cartridge. The potential exists for such continuous spills to cause damage to flooring in the area surrounding the refrigerator. One way in which a filter cartridge can suffer structural damage is when standing water within the cartridge freezes solid. As the water turns to ice, it expands which can lead to the cracking or bursting of the filter housing.

Present filter cartridge designs utilize conventional, rigid polyolefin polymers, usually unmodified talc-filled polypropylene, due to their fatigue and chemical resistance, low cost, low creep and low toxicity. Unfortunately, these materials tend to have glass transition temperatures that cause them to become brittle at temperatures in the freezing range. In addition to becoming brittle, conventional polypropylene resins have an ultimate elongation percentage of approximately 5-30% while above the glass transition temperature. This combination of limited elasticity and brittleness at freezing temperatures makes polypropylene a less than ideal polymer for use in a refrigerator water filter cartridge that must survive freezing conditions.

### SUMMARY OF THE DISCLOSURE

Utilizing a variety of techniques, presently preferred embodiments of a filter cartridge of the present disclosure can resist failure in a freezing event by either incorporating polymers having desired traits, including pressure absorbing elements within the cartridge and/or increasing wall strengths to withstand freeze induced stresses. In one aspect, the disclosure pertains to a freeze resistant water filter. Presently preferred embodiment of freeze resistant water filter can include, for example, the filters substantially describe herein. The disclosure further pertains to the use of freeze resistant water filters as components of water filtration systems as well as to methods and configurations for manufacturing freeze resistant water filters.

In a first presently preferred embodiment, a filter housing is made of a polymer having elongation and glass transition properties that allow for stretching of the filter housing during a freezing event rather than rupturing. Advances in polyolefin chemistry have yielded polymers combining these desired traits of strength and elasticity. A variety of increased elasticity polyolefins such as metallocene modified polypropylene or polyethylene polymers and copolymers, have been developed with ultimate elongation percentages exceeding about 800%, as measured by testing procedure ASTM D638, versus a standard elongation percentage of about 5-30% for conventional polyolefins. Similarly low density polyethylene polymers such as Dow Chemical's Dowlex® can be utilized. Dowlex® has an ultimate elongation percentage exceeding about 750%. In addition, high density polyethylene polyethylene polymers such as Equistar's Alathon® can be utilized. Alathon® has an ultimate elongation percentage exceeding about 1,900%. While these elastic polyolefin polymers have ultimate elongation percentages exceeding about 700%, other elastic polyolefin polymers having ultimate elongation percentages exceeding about 100% could also be used in place of conventional polyolefins. Regardless of the polymer selected, these increased elasticity polyolefins share the traits of considerable strength, increased elasticity, low creep and low cost. These modified polyolefin polymers can be used to manufacture filter housings having thinner walls while still providing adequate strength and elasticity to survive freezing events.

In a variation on this presently preferred embodiment, the filter housing can comprise a plurality of polymers. An elastic polyolefin can be selected as the housing polymer based on its elasticity and strength traits while the interface cap polymer is chosen for its strength and rigidity characteristics.

In another presently preferred embodiment, a volume of air is entrapped within the interior of the filter cartridge during manufacturing. This entrapped air can be present in the form of closed-cell foam or suitable non-popping bubble wrap. During a freezing event, this entrapped air allows ice to expand inwardly by compressing the entrapped air rather than expanding outwardly against the cartridge housing. As outward expansion against the cartridge housing has been reduced, such a design could include a reduced wall thickness for the cartridge housing.

In another presently preferred embodiment, the aforementioned embodiments can be combined in a variety of configurations so as to yield a filter housing constructed of polymers having desired elasticity and strength traits while incorporating entrapped air within the interior volume of the cartridge filter.

In another presently preferred embodiment, a cartridge filter can be designed using standard unmodified polyolefin construction, most typically unmodified talc-filled polypropylene, for the filter housing itself. A filter element is selected that has a reduced porosity throughout its thickness such that the amount of entrained water available to freeze is reduced. Despite the inherent traits of unmodified polypropylene, the filter cartridge can be constructed using a wall thickness great enough to resist the freeze induced expansion stresses of this reduced water volume.

In another presently preferred representative embodiment, a cartridge filter of the present disclosure comprises a filter cap, a filter housing and a filter element. The filter cap and filter housing both include threaded portions allowing for rotatable attachment of the filter cap and filter housing. Cap engagement members on the filter cap and housing engagement members on the filter housing allow for rotatable connection of filter cap and filter housing but lockingly engage to prevent rotatable disconnection of the filter cap and filter housing. In particular, the locking structure can result in a permanently sealed cartridge filter in the sense that overriding of the locking structure may break the lock and possibly destroy other elements of the cartridge. Specific locking structures are described below, and the locking structure generally involves insertion of one element into another element in which the insertion resists rotation to disconnect the elements of the cartridge. Within these general parameters, a variety of locking structures are suitable.

### BRIEF DESCRIPTION OF THE DRAWINGS

FIG. 1 is a perspective view of a burst filter cartridge.

FIG. 2 is an exploded perspective view of an embodiment of a freeze resistant filter cartridge.

FIG. 3 is a perspective, view of an end of the freeze resistant filter cartridge of FIG. 2.

FIG. 4 is a sectional, perspective view of an end of the freeze resistant filter cartridge of FIG. 2.

FIG. 5 is an exploded perspective view of an embodiment of a freeze resistant filter cartridge.

FIG. 6 is a sectional, perspective view of a cartridge housing for the filter cartridge of FIG. 5.

FIG. 7 is a sectional, perspective view of the cartridge housing for the filter cartridge of FIG. 5.

FIG. 8 is a sectional, side view of the filter cartridge of FIG. 5.

FIG. 9 is an exploded perspective view of an embodiment of a freeze resistant filter cartridge.

FIG. 10 is a side view of the filter cartridge of FIG. 9.

FIG. 11 is a top, perspective view of a cartridge head for the filter cartridge of FIG. 9.

FIG. 12 is a bottom, perspective view of a cartridge head for the filter cartridge of FIG. 9.

FIG. 13 is a perspective view of a cartridge housing for the filter cartridge of FIG. 9.

FIG. 14 is a side view of the cartridge housing for the filter cartridge of FIG. 9.

FIG. 15 is a sectional, side view of the filter cartridge of FIG. 9.

FIG. 16 is a sectional, side view of the filter cartridge of FIG. 9.

FIG. 17 is an exploded perspective view of an embodiment of a freeze resistant filter cartridge.

FIG. 18 is a sectional, side view of the filter cartridge of FIG. 17.

FIG. 19 is a side view of an embodiment of a freeze resistant filter cartridge.

FIG. 20 is a sectional, side view of the filter cartridge of FIG. 19.

FIG. 21 is an exploded, perspective view of a presently preferred representative embodiment of a cartridge filter assembled with locked threads.

FIG. 22 is a side view of the cartridge filter of FIG. 21.

FIG. 23 is a perspective, end view of a threadably attachable filter cap for use in the cartridge filter of FIG. 21.

FIG. 24 is a threaded end view of the threadably attachable filter cap of FIG. 23.

FIG. 25 is an opposite end view of the threadably attachable filter cap of FIG. 23, which illustrates the opposite end view relative to FIG. 24.

FIG. 26 is a side view of the threadably attachable filter cap of FIG. 23.

FIG. 27 is a section view of the threadably attachable filter of FIG. 23 taken at line 27-27 of FIG. 26.

FIG. 28 is a perspective, end view of a threadably attachable filter housing for use in the cartridge filter of FIG. 21.

FIG. 29 is a side view of the threadably attachable filter housing of FIG. 28.

FIG. 30 is a section view of the threadably attachable filter housing of FIG. 28 taken at line 30-30 of FIG. 29.

FIG. 31 is a section view of an indented region of the threadably attachable filter housing of FIG. 28.

FIG. 32 is a partial, section view of the cartridge filter of FIG. 21.

### DETAILED DESCRIPTION OF THE PRESENTLY PREFERRED EMBODIMENTS

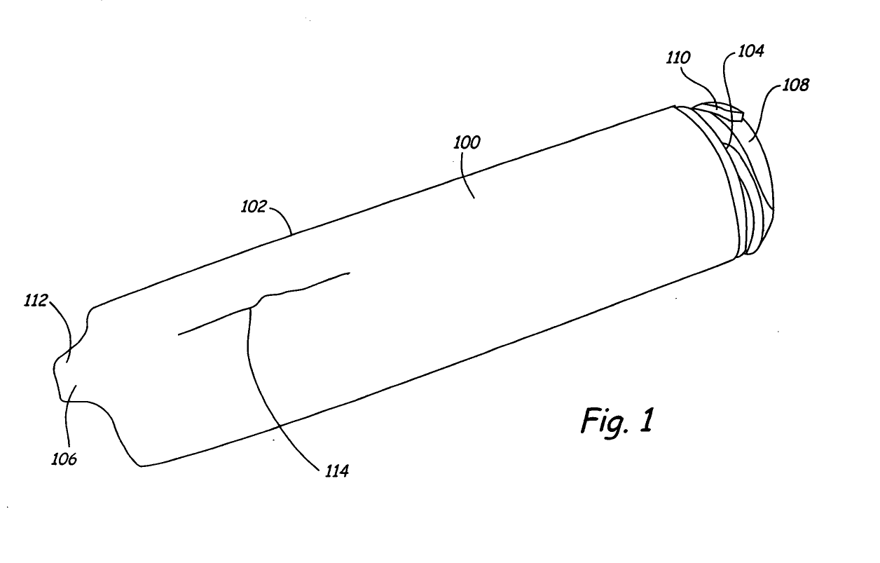

Illustrated in FIG. 1 is a commercially available residential filter cartridge 100 following prolonged exposure to freezing conditions. As is typical of most commercially available cartridges, filter cartridge 100 is made of a conventional rigid, unmodified talc-filled polypropylene polymer. Filter cartridge 100 is comprised of a generally cylindrical housing 102 and a cartridge head 104. Filter cartridge 100 is defined by a biasing end 106 and an engagement end 108. Cartridge head 104 includes an interconnecting member 110, illustrated as an insertion ramp, that interfaces with a water distribution manifold. Biasing end 106 includes a projecting grip 112 for use when attaching or removing filter cartridge 100 from the water distribution manifold. Evident on the surface of filter cartridge 100 is a brittle fracture 114 extending linearly along the length of the filter cartridge 100. Fracture 114 is a representative failure mode for filter cartridge 100 constructed of conventional polyolefin polymers following prolonged exposure to freezing conditions during actual use. Fracture 114 is caused by expansion stresses created during the formation of ice from liquid water causing filter cartridge 100 to burst.

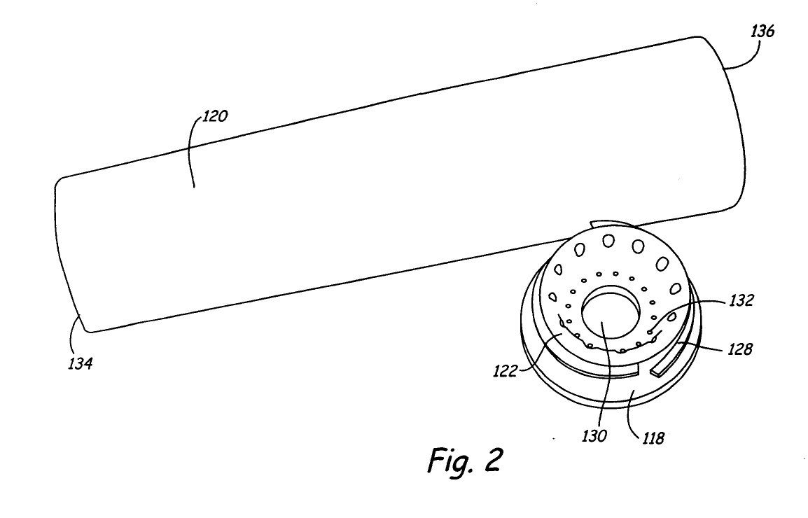

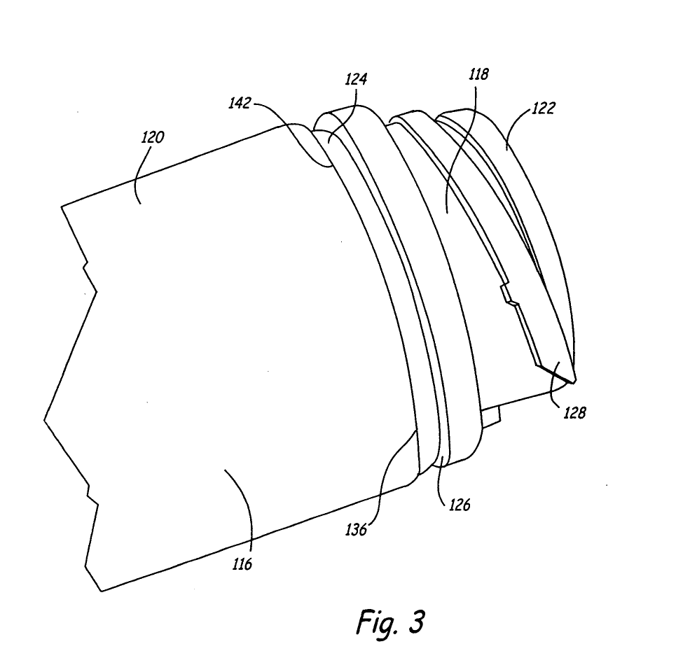

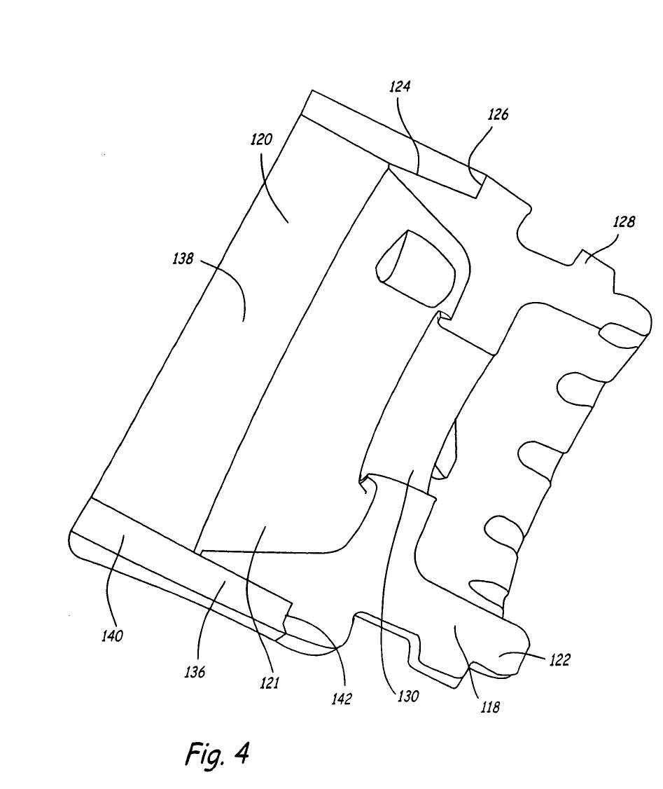

FIGS. 2, 3 and 4 depict an embodiment of a freeze resistant filter cartridge 116. Filter cartridge 116 comprises a cartridge head 118 and an elastic cartridge housing 120. Cartridge housing 120 is preferably constructed of an increased elasticity polyolefin polymer having an ultimate elongation percentage exceeding at least about 100% and in some embodiments exceeding about 700%, as well as values between these elongation percentages. Examples of suitable polyolefin polymers include metallocene modified polypropylenes (i.e., metallocene-plastomer modified polypropylenes) and polyethylenes (i.e., metallocene-plastomer modified polyethylenes), low density polyethylenes, high density polyethylenes, bimodal polyethylenes and poly(ethylene-co-propylene). Preferably, cartridge head 118 is constructed of the same modified polyolefin polymer as cartridge housing 120. Alternatively, cartridge head 118 can comprise other polyolefin polymers that exhibit bonding properties making it compatible for use with the elastic polyolefin polymer of cartridge housing 120. Generally, cartridge head 118 and cartridge housing 120 are formed using a variety of forming processes including but not limited to injection molding, compression molding and extrusion. As cartridge head 118 and cartridge housing 120 preferably comprise the same polymer or alternatively comprise compatible polymers, a wide variety of bonding methods can be used to construct filter cartridge 116. Methods for bonding cartridge head 118 and cartridge housing 120 could include but are not limited to spin welding, hot-plate, electromagnetic radiation heating, sonic welding, adhesive bonding, laser welding or any combination thereof. Generally, cartridge head 118 includes an insertion end 121 and a connecting end 122. Insertion end 121 includes an insertion surface 124 and an insertion flange 126. Connecting end 122 includes a connection member 128. Cartridge head 118 also includes a central inlet bore 130 and a plurality of outlet bores 132. Cartridge housing 120 includes a closed end 134, an open end 136, an interior cavity 138, a cartridge wall 140 and a sealing face 142.

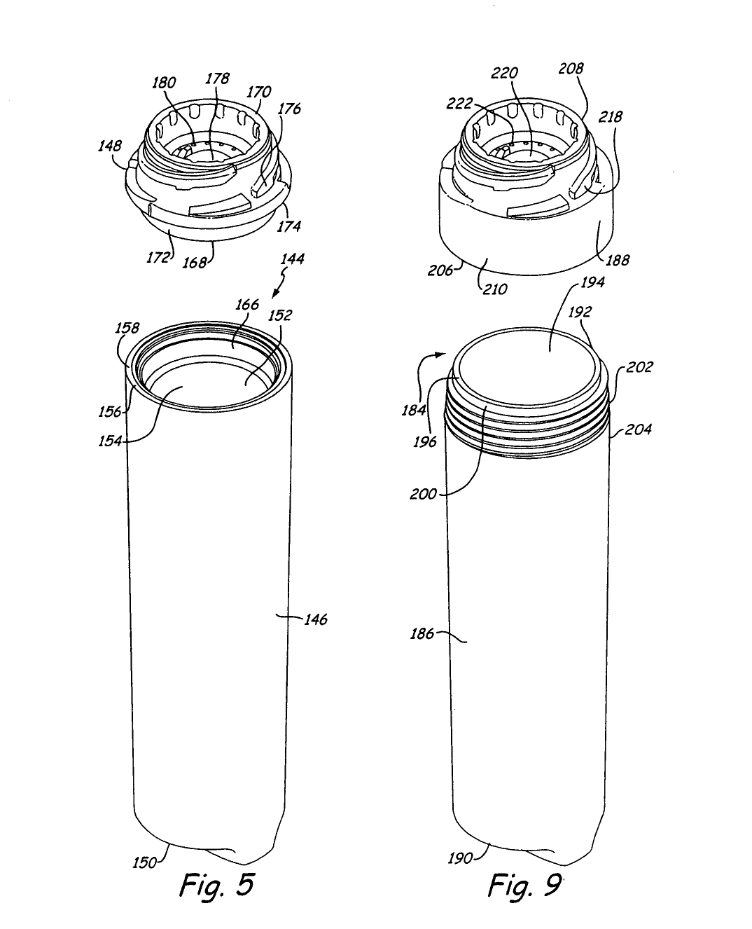

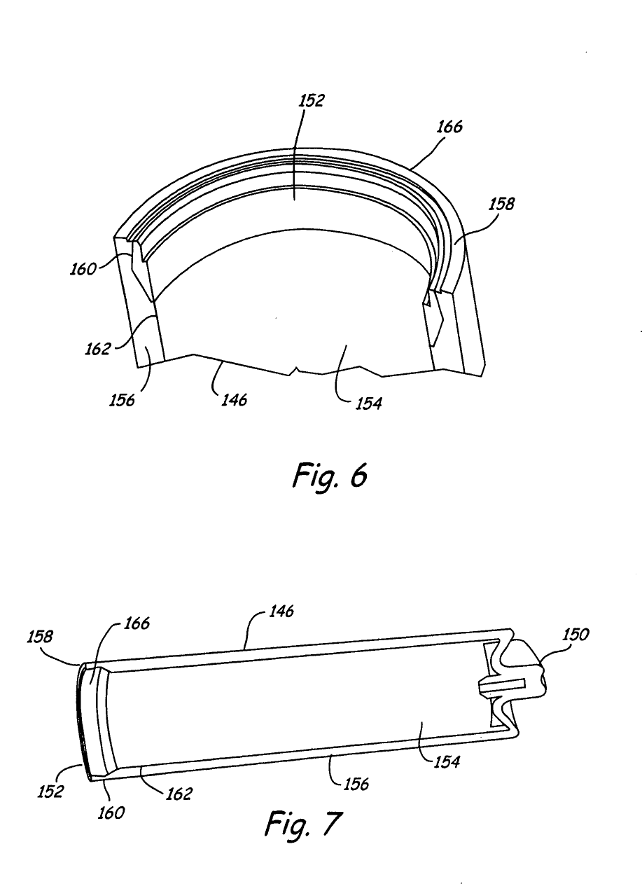

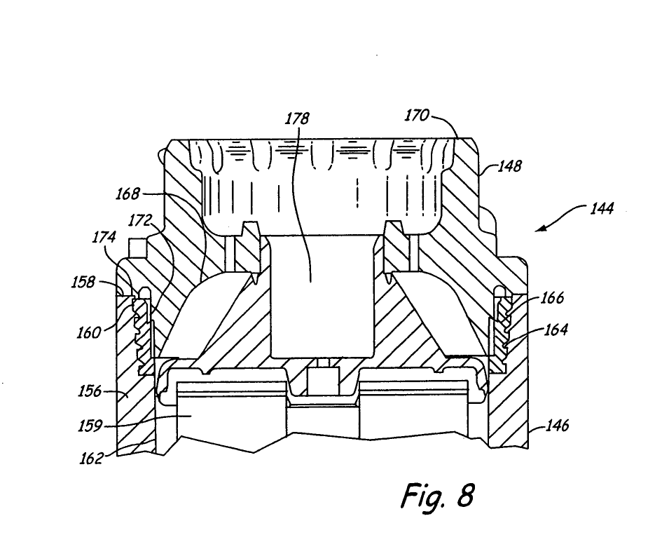

In FIGS. 5, 6, 7 and 8, an alternative embodiment of a freeze resistant filter cartridge 144 is illustrated. Filter cartridge 144 includes an elastic cartridge housing 146 and a rigid cartridge head 148. Cartridge housing 146 comprises a polyolefin polymer having an ultimate elongation percentage exceeding at least about 100% and in some embodiments exceeding about 700%, as well as values between these elongation percentages. Examples of suitable polyolefin polymers include metallocene modified polypropylenes and polyethylenes, low density polyethylenes and high density polyethylenes. Cartridge head 148 comprises a conventional rigid polyolefin polymer such as polypropylene. Generally, cartridge head 148 and cartridge housing 146 are formed using a variety of forming processes including but not limited to injection molding, compression molding and extrusion. In this embodiment, cartridge housing 146 includes a closed end 150, an open end 152, an interior cavity 154, a cartridge wall 156 and a sealing face 158. Generally, a filter element 159 is located within interior cavity 154. Located at open end 152 is a circumferential groove 160 in an inner wall surface 162. Circumferential groove 160 includes a plurality of molded protrusions 164 extending from the inner wall surface 162. Located within circumferential groove 160 and fixedly attached to molded protrusions 164 as shown in these Figures, is a molded insert weld-ring 166. Weld-ring 166 can be comprised of the same polyolefin polymer as rigid cartridge head 148, however, weld-ring 166 could comprise any polymer, other than the polymer comprising cartridge housing 146, capable of bonding with rigid cartridge head 148. For example, when forming the cartridge housing 146, weld-ring 166 can be pre-molded and placed within the mold for the cartridge housing 146 although other inset molding techniques could be used. Such bonding methods could include but are not limited to spin welding, hot-plate, electromagnetic radiation heating, sonic welding, adhesive bonding, laser welding or any combination thereof. Generally, cartridge head 148 includes an insertion end 168 and a connecting end 170. Insertion end 168 includes an insertion surface 172 and an insertion flange 174. Connecting end 170 includes a connection member 176. Cartridge head 148 also includes a central inlet bore 178 and a plurality of outlet bores 180. In alternative embodiments, cartridge housing 146 can integrally include structure corresponding to insert weld-ring 166 if the polymer of elastic cartridge housing 146 is appropriately bondable to rigid cartridge head 148. In this alternative embodiment, the structure is as shown in FIGS. 5, 6, 7 and 8 except that the material of cartridge housing 146 is uniform instead of a composite of two materials.

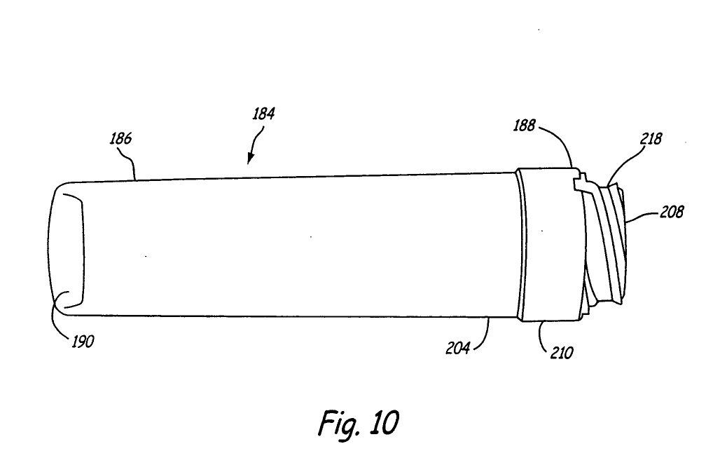

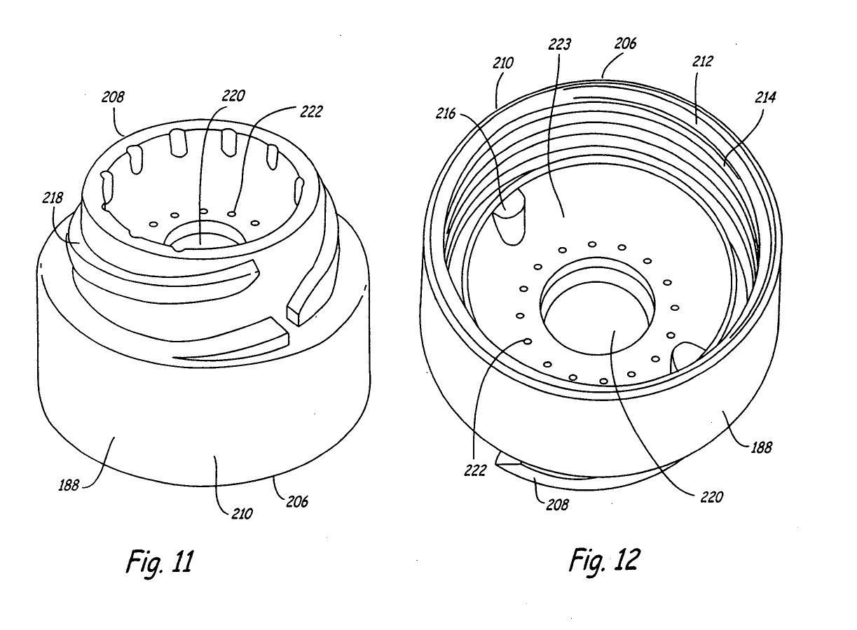

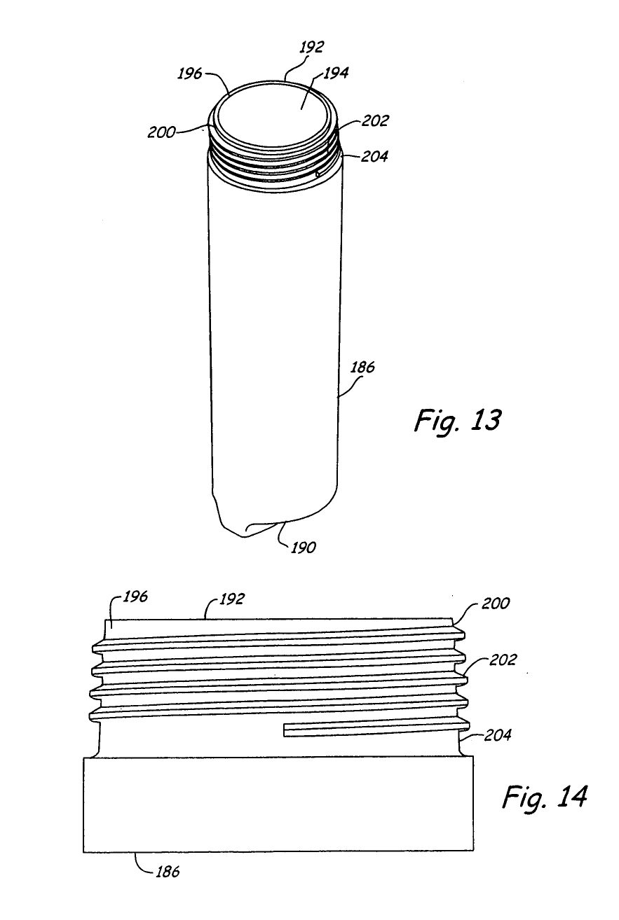

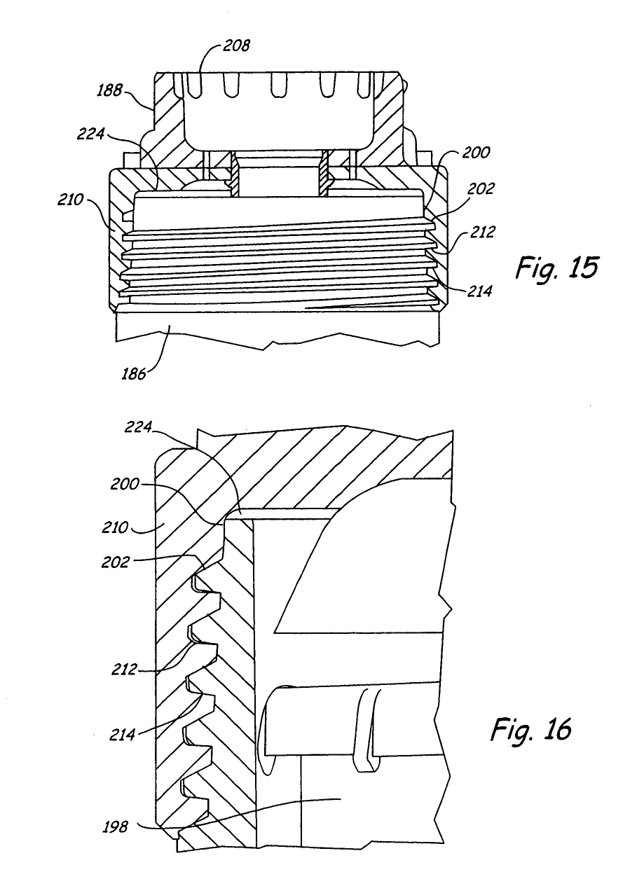

Illustrated in FIGS. 9, 10, 11, 12, 13, 14, 15 and 16 is another alternative embodiment of a freeze resistant filter cartridge 184. Filter cartridge 184 includes an elastic cartridge housing 186 and a rigid cartridge head 188. Cartridge housing 186 comprises a polyolefin polymer having an ultimate elongation percentage exceeding at least about 100% and in some embodiments exceeding about 700%, as well as values between these elongation percentages. Examples of suitable polyolefin polymers include metallocene modified polypropylenes and polyethylenes, low density polyethylenes and high density polyethylenes. Cartridge head 188 comprises a conventional rigid polyolefin polymer such as polypropylene. Generally, cartridge head 188 and cartridge housing 186 are formed using a variety of forming processes including but not limited to injection molding, compression molding and extrusion. In this embodiment, cartridge housing 186 includes a closed end 190, an open end 192, an interior cavity 194 and a cartridge wall 196. Generally, a filter element 198 is located within interior cavity 194. Open end 192 includes a guiding surface 200 and a circumferential, external thread 202 around outer wall surface 204. Cartridge head 188 includes an insertion end 206 and a connecting end 208. Insertion end 206 includes an insertion wall 210. Insertion wall 210 has a diameter slightly larger than open end 192. Insertion wall 210 includes an inside surface 212 with an internal thread 214. Insertion end 206 also includes an insertion stop 216. Connecting end 208 includes a connection member 218. Cartridge head 188 also includes a central inlet bore 220, a plurality of outlet bores 222 and a trough 223 surrounding central inlet bore 220. When cartridge head 188 and cartridge housing 186 are attached, a gap 224 is created.

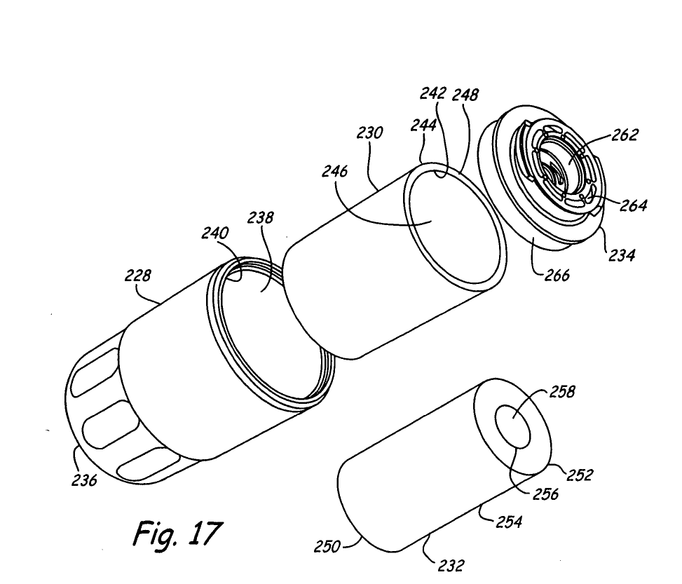

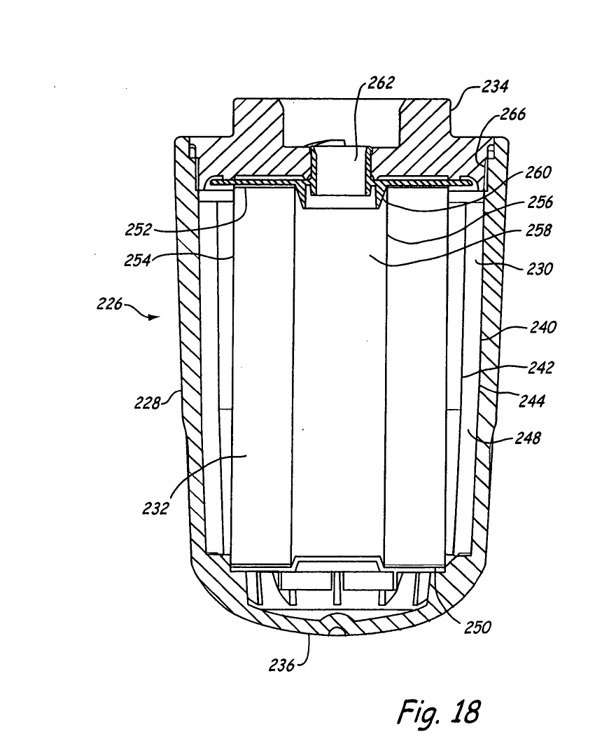

FIGS. 17 and 18 depict an alternative embodiment of a freeze resistant filter cartridge 226. Filter cartridge 226 consists of a cartridge housing 228, a compression sleeve 230, a filter element 232 and a cartridge head 234. Generally, cartridge head 234 and cartridge housing 228 are formed using a variety of forming processes including but not limited to injection molding, compression molding and extrusion. Cartridge housing 228 has a generally cylindrical configuration defined by a close end 236, an open end 238 and an inner wall 240. Compression sleeve 230 has a generally cylindrical configuration defined by an inner sleeve wall 242 and an outer sleeve wall 244. Inner sleeve wall 242 defines a sleeve cavity 246. Inner sleeve wall 242 and outer sleeve wall 244 define a sealed air pocket 248. Examples of sealed air pocket 248 include entrapped air present in the form of closed-cell foam or suitable non-popping bubble wrap. Filter element 232 has a generally cylindrical configuration defined by a distal end 250, a proximal end 252, an outer element wall 254, an inner element wall 256 and a continuous through-bore 258. Cartridge head 234 includes a projecting interface 260, a central inlet bore 262, a plurality of outlet bores 264 and a collar 266.

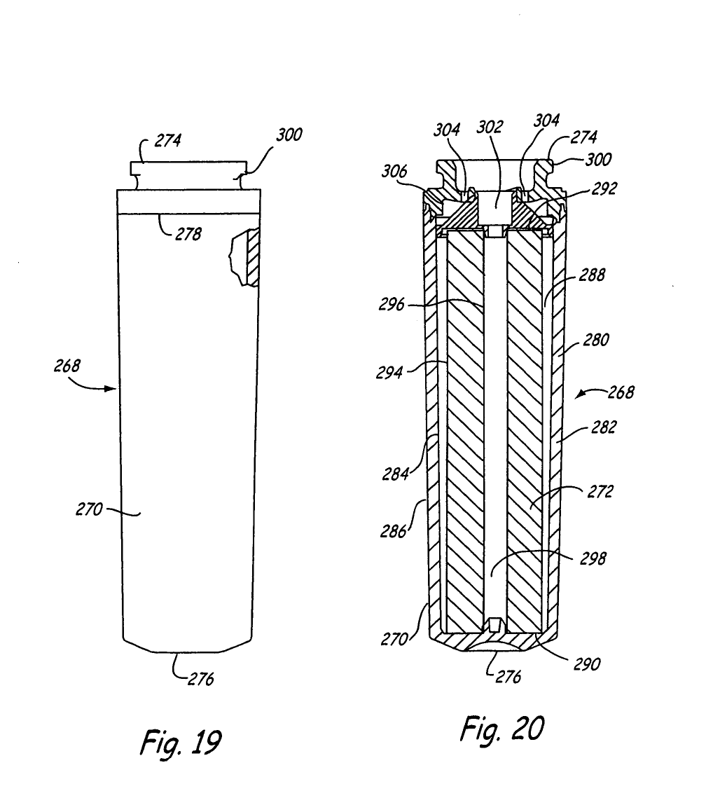

FIGS. 19 and 20 depict another alternative embodiment of a freeze resistant filter cartridge 268. Filter cartridge 268 includes a cartridge housing 270, a filter element 272 and a cartridge head 274. Generally, cartridge head 274 and cartridge housing 270 are formed using a variety of forming processes including but not limited to injection molding, compression molding and extrusion. Cartridge housing 270 has a generally cylindrical configuration defined by a closed end 276, an open end 278 and a wall 280. Wall 280 has a wall thickness 282 defined by an inner wall surface 284 and an exterior wall surface 286. Preferably, wall thickness 282 is selected from the range of about 1/8 inch to about ½ inch. Interior wall surface 284, closed end 276 and open end 278 define an interior cavity 288. Filter element 272 has a generally cylindrical configuration defined by a distal end 290, a proximal end 292, an outer element wall 294, an inner element wall 296 and a continuous through-bore 298. Cartridge head 274 includes a projecting interface 300, a central inlet bore 302, a plurality of outlet bores 304 and a collar 306.

In the first embodiment illustrated in FIGS. 2, 3 and 4, the filter cartridge 116 includes a filter element (not shown) mounted within interior cavity 138. This filter element is likely to be similar in appearance and construction to filter element 159. The filter element is held in position by permanently attaching cartridge head 118 to elastic cartridge housing 120. Insertion surface 124 is inserted into interior cavity 138 until insertion flange 126 comes into contact with sealing face 142. Insertion flange 126 and sealing face 142 are permanently bonded to complete the assembly of filter cartridge 116. In practice, the cartridge head 118 of filter cartridge 116 will be interconnectable to a filter manifold (not shown).

In an alternative embodiment illustrated in FIGS. 5, 6, 7, and 8, filter cartridge 144 includes filter element 159 mounted within interior cavity 154. Filter element 159 can comprise a variety of filtering media including but not limited to depth filtration media, absolute filtration media, activated carbon media, ion exchange media and any combination thereof. Filter element 159 can be held in position by permanently attaching rigid cartridge head 148 to elastic cartridge housing 146. As rigid cartridge head 148 and elastic cartridge housing 146 comprise different polymers, standard attachment methods may not be applicable. In order to promote attachment, weld-ring 166 can be insert molded into circumferential groove 160. Molded protrusions 164 promote adherence of weld-ring 166 and elastic cartridge housing 146. Weld-ring 166 can comprise the same polymer as rigid cartridge head 148, though any polymer capable of bonding to rigid cartridge head 148 could be used. Insertion surface 172 is inserted into interior cavity 154 until insertion flange 174 comes into contact with sealing face 158. Rigid cartridge head 148 and elastic cartridge housing 146 can the be permanently bonded to complete the assembly of filter cartridge 116. As discussed previously, elastic cartridge housing 146 can integrally include structure corresponding to insert weld-ring 166 which would be bondable to rigid cartridge head 148 using the same bonding methods.

In another alternative embodiment illustrated in FIGS. 9, 10, 11, 12, 13, 14, 15 and 16, filter cartridge 184 includes filter element 198 mounted within interior cavity 194. Filter element 198 can comprise a variety of filtering media including but not limited to depth filtration media, absolute filtration media, activated carbon media, ion exchange media and any combination thereof. Filter element 198 is held in position by attaching rigid cartridge head 188 to elastic cartridge housing 186. Guiding surface 200 is positioned within insertion end 206 until external thread 202 is in contact with internal thread 214. Rigid cartridge head 188 and elastic cartridge housing 186 are then rotatably interconnected by way of internal thread 214 and external thread 202. Preferably, an amount of hot melt glue or other suitable adhesive, such as epoxy, is applied to trough 223 prior to threading rigid cartridge head 188 to elastic cartridge housing 186. The hot melt glue or adhesive serves to permanently bond rigid cartridge head 188 to elastic cartridge housing 186 to complete filter cartridge 182, preferably by bonding internal thread 214 and external thread 202. In addition to bonding cartridge head 188 and elastic cartridge housing 186, hot melt glue or adhesive fills gap 224 and acts as a gasket or seal to prevent water leakage.

In another alternative embodiment illustrated in FIGS. 17 and 18, filter cartridge 226 is assembled by placing compression sleeve 230 into open end 238 of cartridge housing 228 such that outer sleeve wall 244 and inner wall 240 are in contact. Next, filter element 232 is placed within sleeve cavity 246 of compression sleeve 230. Filter element 226 can comprise a variety of filtering media including but not limited to depth filtration media, absolute filtration media, activated carbon media, ion exchange media and any combination thereof. Filter element 226 is held in position by attaching cartridge head 234 to cartridge housing 228. Projecting interface 260 is positioned so that it inserts into through-bore 258 of filter element 232. Collar 266 inserts into open end 238 of cartridge housing 228 facilitating the bonding of cartridge head 234 and cartridge housing 228. Bonding can take by place by any number of suitable methods including but not limited to spin welding, hot-plate, electromagnetic radiation heating, sonic welding, adhesive bonding, laser welding or any combination thereof.

In another alternative embodiment illustrated in FIGS. 19 and 20, filter cartridge 268 is assembled by placing filter element 272 into open end 278 of cartridge housing 270 such that distal end 290 is in proximity to closed end 276. Filter element 272 can comprise a variety of filtering media including but not limited to depth filtration media, absolute filtration media, activated carbon media, ion exchange media and any combination thereof. Preferably, filter element 272 is manufactured such that it has a reduced internal porosity to assist in reducing the volume of entrained water. Filter element 272 is held in position by attaching cartridge head 274 to cartridge housing 270. Collar 306 is positioned so that it inserts into open end 278 and inlet bore 302 and through-bore 298 are in alignment. Cartridge head 274 can be bonded to cartridge housing 270 by any suitable method including but not limited to spin welding, hot-plate, electromagnetic radiation heating, sonic welding, adhesive bonding, laser welding or any combination thereof.

In practice, the cartridge filters of the present disclosure are used in conjunction with water filtration systems used in appliance such as refrigerators. Examples of representative filter systems are disclosed in U.S. Pat. Nos. 5,753,107, 6,027,644, and 6,193,884 as well as in U.S. patent application Ser. No. 09/918,316, entitled “Low Spillage Replaceable Water Filter Assembly and Ser. No. 10/202,290, entitled “Hot Disconnect Replaceable Water Filter Assembly”, all of which are hereby incorporated by reference to the extent not inconsistent with the present disclosure. Generally, unfiltered water flows from a water source (not illustrated) to a water manifold (not illustrated). From the water manifold, water is directed into a filter cartridge. This filter cartridge could be any of the aforementioned embodiments. Unfiltered water flows into the filter cartridge, through the filter element, out the filter cartridge, into the manifold as filtered water and then to the points of use. When filtered water is not being used, the open volume of filter cartridge is filled with water. If the filter cartridge is exposed to freezing conditions, water can begin to freeze and begin to expand. As the water turns to ice and expands, the ice will expand outwardly subjecting the filter cartridge to expansion stresses.

When filter cartridge 116 is exposed to expansion stress, elastic cartridge housing 120 begins to stretch, expand and deform rather than bursting and suffering a failure such as fracture 114. Because cartridge housing 120 is comprised of an increased elasticity polyolefin polymer having an increased ultimate elongation percentage, the integrity of filter cartridge 116 is maintained.

When filter cartridge 144 is exposed to expansion stress, elastic cartridge housing 146 begins to stretch, expand and deform rather than bursting and suffering a failure such as brittle fracture 112. Because cartridge housing 146 is comprised of an increased elasticity polyolefin polymer having an increased ultimate elongation percentage, the integrity of filter cartridge 144 is maintained. In addition, the strength of rigid cartridge head 148 prevents rigid cartridge head 148 from stretching, expanding or deforming. By maintaining its physical shape, rigid cartridge head 148 remains attached to the manifold and eliminates any possible leaking that could occur through warping and disengaging from the manifold.

When filter cartridge 184 is exposed to expansion stress, elastic cartridge housing 186 begins to stretch, expand and deform rather than bursting and suffering a failure such as fracture 112. Because cartridge housing 186 is comprised of an increased elasticity polyolefin polymer having an increased ultimate elongation percentage, the integrity of filter cartridge 184 is maintained. In addition, the strength of rigid cartridge head 188 prevents rigid cartridge head 188 from stretching, expanding or deforming. By maintaining its physical shape, rigid cartridge head 188 remains attached to the manifold and eliminates any possible leaking that could occur through warping and disengaging from the manifold.

Prior to installation of filter cartridge 226, compression sleeve 230 is subject only to atmospheric pressure. Once filter cartridge 226 is installed, compression sleeve 230 is exposed to line pressure resulting in compression of compression sleeve 230 to a first compression. When exposed to freezing conditions, ice created expansion stress will expand against compression sleeve 230, compressing air pockets 248 to a second compression. This expansion serves to compress air pockets 248 so that cartridge housing 228 does not experience all of the resulting expansion forces. Because compression sleeve 230 compresses as the ice expands, cartridge housing 228 does not experience the full expansion force, which may be in excess of the burst pressure. The physical characteristics of compression sleeve 230 including thickness and volume of trapped air can be altered so as to allow adjustments to the wall thickness, geometry or polymer composition of cartridge housing 228.

When filter cartridge 268 is exposed to freezing conditions, the volume of water present in cartridge housing 270 is preferably low enough that the expansion stress of the ice does not result in excessive stretching, expansion and deformation of the filter cartridge 268. By using a filter element 272 having a reduced capacity for entraining water, less water is available to freeze. In addition, the wall thickness 282 is high enough to resist any expansion stress caused by the available water turning to ice.

In the embodiments described above, several approaches are described for sealing the filtration material within the filter cartridge. Whether or not the cartridge housing is designed to resist freezing based on the approaches described above, processing advantages can be obtained using a filter housing that is sealed using two components with a locking, threaded engagement mechanism. Thus, using a self-locking engagement structure, the two components are rotated to engage the threads until the locking structure engages. Then, the filter cartridge is permanently sealed with the filtration material within the filter cartridge.

Another presently preferred representative embodiment of a cartridge filter 400 is illustrated in FIGS. 21 and 22 in which filter cartridge 400 has a housing that is formed from the joining of two threadably lockable components. Specifically, in this embodiment cartridge filter 400 comprises a filter cap 402, a filter seal 404, a filter dam 406, a filter element 408 and a filter housing 410. Filter seal 404 can comprise a rubber-like seal such as, for example, an o-ring seal fabricated of suitable elastomers such as, for example, polypropylene, silicone, EPDM, fluroelastomers and the like. Filter seal 404 can comprise alternative configurations such as, for example, a seal overmolded integrally to the filter cap 402 or filter housing 410. Filter dam 406 comprises a dam engagement surface 412 for fluidly sealing and directing flow from the filter element 408. Alternatively or additionally, filter dam 406 can be attached to filter cap 402 or integrally molded with filter cap 402. When cartridge filter 400 is fully assembled, a dam throughbore 414 fluidly interconnects the filter cap 402 with an interior portion of the filter element 408. Filter element 408 can comprise a cylindrical filter element with a hollow interior portion such that filtration is accomplished through a filter wall 416 to the hollow interior portion. Filter wall 416 can be comprised of suitable filter media such as, for example, activated carbon media, ceramic filter media, blown fiber media and the like.

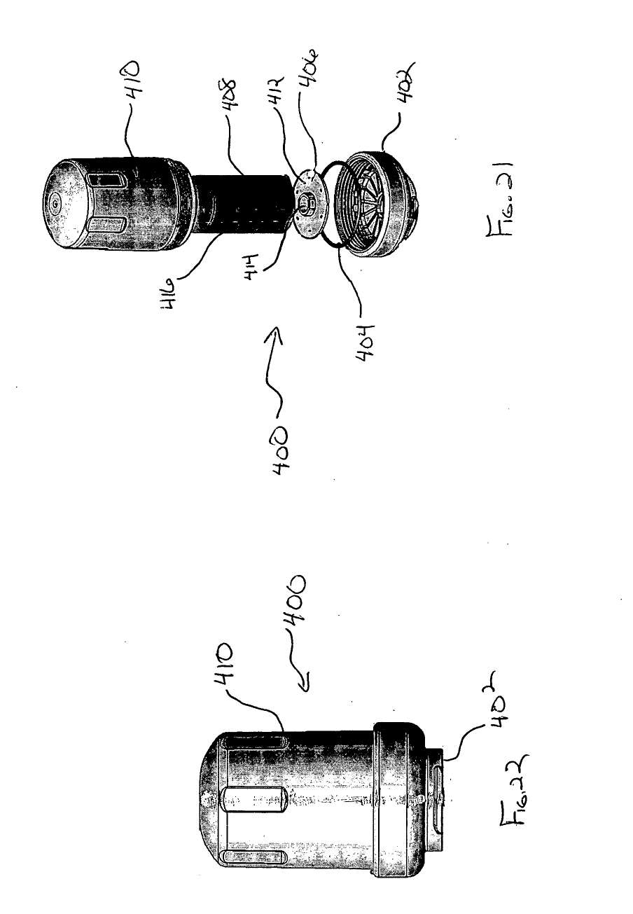

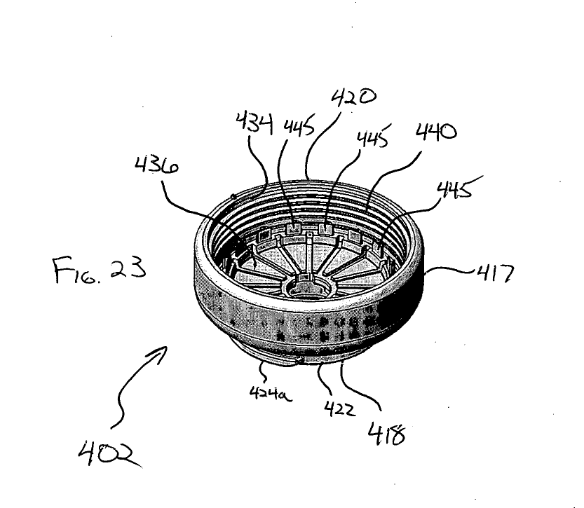

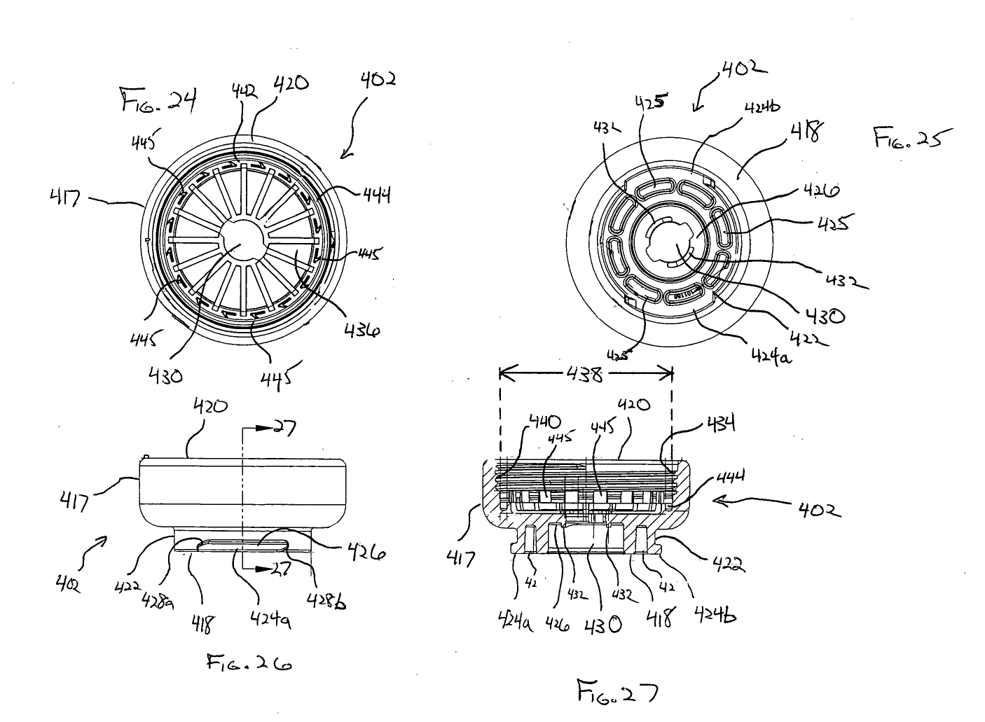

As illustrated in FIGS. 23, 24, 25, 26 and 27, filter cap 402 comprises a cap body 417 having an engagement end 418 and an attachment end 420. Engagement end 418 comprises a projecting wall 422 having a pair of opposed engagement tabs 424a, 424b and a plurality of feed throughbores 425. Engagement tabs 424a, 424b can take the form of a tab 426 with angled engagement portions 428a, 428b as shown in FIG. 26 or alternatively, engagement tabs 424a, 424b can be replaced with, for example, continuous helical threads wrapped about the projection wall 422, or in another alternative embodiment, engagement tabs 424a, 424b can be replaced, for example, with multi-stage engagement ramps located on projection wall 422, the continuous helical threads and multi-stage engagement ramps both being disclosed in U.S. patent application Ser. No. 11/013,269, which is herein incorporated by reference to the extent not inconsistent with the present disclosure. Basically, engagement tabs 424a, 424b and their alternatives provide for rotatable, releasable engagement of the filter cartridge with a manifold assembly to provide a filtration system. In addition, filter cap 402 can comprise other suitable features and configurations so as to allow for sealable attachment of the cartridge filter 400 with a manifold assembly such as, for example, features and configurations as shown in U.S. Pat. Nos. 4,735,716, 4,877,521 and 4,948,505, all of which are herein incorporated by reference to the extent not inconsistent with the present disclosure. Engagement end 418 further comprises a manifold engagement surface 426 having a return throughbore 430 and a pair of opposed engagement ramps 432. Feed throughbores 428 and return throughbore 430 fluidly interconnect the engagement end 418 with the attachment end 420.

Attachment end 420 comprises an internal wall 434 and an internal distribution surface 436. Internal wall 434 has an internal diameter 438 that corresponds with a suitable size to engage threads on filter housing 410. Internal wall 434 comprises a cap thread 440. Internal distribution surface 436 comprises an internal projection wall 442 and a seal groove 444. Internal projection wall 442 comprises a plurality of spaced apart cap engagement members 445. Cap engagement members 445 can comprise receivers such as, for example, grooves, cavities, and channels or cap engagement members 445 can comprise projections such as for example, angled tabs, bumps and ridges or alternatively, cap engagement members 445 can comprise combinations of receivers and projections.

In some presently preferred representative embodiments, filter cap 402 can be fabricated of a suitable rigid polyolefin polymer such as, for example, polypropylene. In some alternative representative embodiments, filter cap 402 can be fabricated of a plurality of polymers such as, for example, fabricating the cap body 417 of a polyolefin polymer having an ultimate elongation percentage exceeding at least about 100%, while the engagement tabs 424a, 424b comprise a rigid polyolefin polymer through the use of a suitable fabrication method such as, for example, insert molding, such that the filter cap 402 comprises the dual benefits of increased elasticity for freeze resistance and increased strength for coupling the cartridge filter 400 to a manifold assembly.

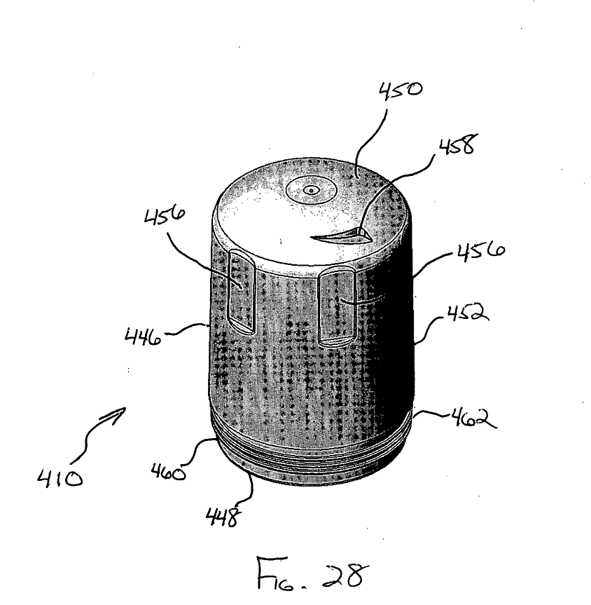

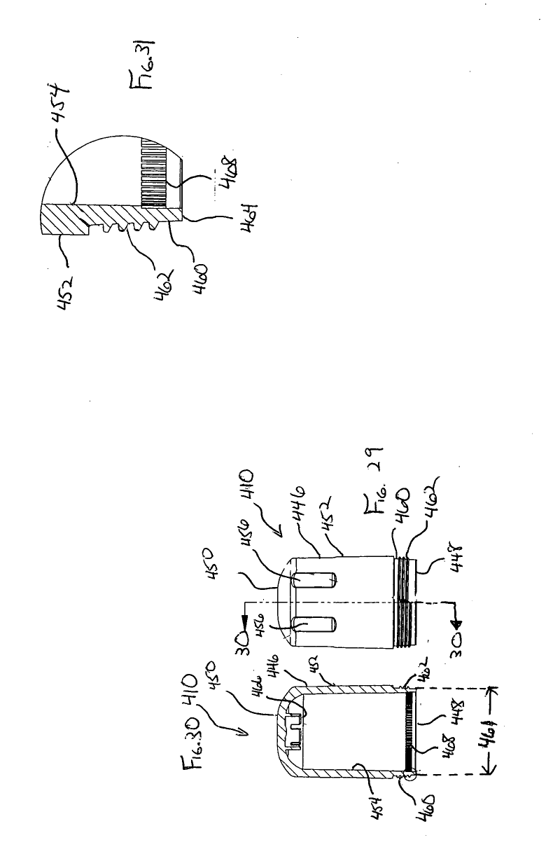

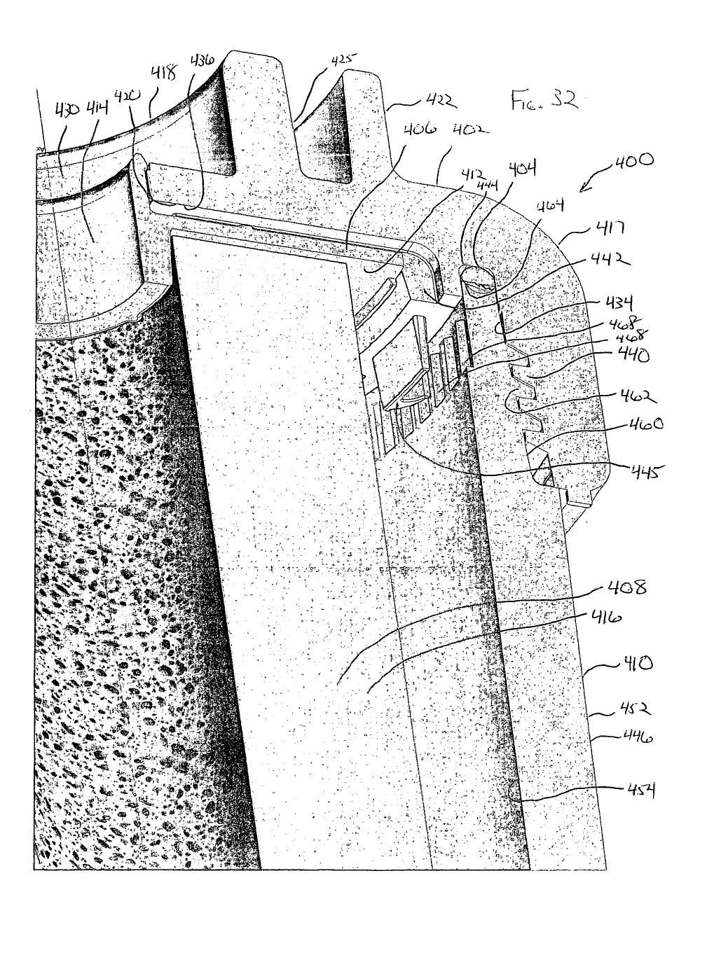

As illustrated in FIGS. 28, 29, 30 and 31, filter housing 410 generally comprises a housing body 446 having an open end 448 and a closed end 450. Housing body 442 is generally defined by an external housing wall 452 and an internal housing wall 454. External housing wall 452 can comprise a plurality of spaced apart gripping indents 456 and a rotational direction indicator 458. External housing wall 452 can further comprise an indented region 460 proximate the open end 448. Indented region 460 comprises an indented external diameter 461 selected to be similar to internal diameter 438 such that cap 402 can engage indented region 460. Indented region 460 further comprises a housing thread 462 and a sealing surface 464. Internal housing wall 454 can comprise a filter positioning projection 466 at closed end 450 and a plurality of spaced apart housing engagement members 468 proximate the open end 448. Housing engagement members 468 can comprise receivers such as, for example, grooves, cavities, and channels or housing engagement members 468 can comprise projections such as for example, angled tabs, bumps and ridges or alternatively, housing engagement members 468 can comprise combinations of receivers and projections. In some presently preferred representative embodiments, filter housing 410 can be fabricated of a polyolefin polymer having an ultimate elongation percentage exceeding at least about 100%.

Cartridge filter 400 can be assembled by first attaching the filter dam 406 to the filter element 408 through the use of a suitable attachment mechanism such as, for example adhesively, sonically or thermally or other sufficiently operative attachment means as currently known to those skilled in the art or subsequently becomes available for use in this manner. Filter element 408 is then directed into the open end 448 of filter housing 410 such that the filter element 408 is abutting engaged and positioned by the filter positioning projection 466. Either prior to or after positioning the filter element 408 within the filter housing 410, filter seal 404 is positioned within the seal groove 444 on filter cap 402.

Filter cap 402 and filter housing 410 are oriented as shown in FIG. 21 such that attachment end 420 is proximate open end 448. The indented region 460 is slidingly inserted into the attachment end 420 so as to engage the housing thread 462 with the cap thread 440. Filter cap 402 and filter housing 410 can then be rotatably engaged through the interface between the housing thread 462 and cap thread 440 such that the open end 448 is drawn toward the internal distribution surface 436. As open end 448 approaches the internal distribution surface 436, filter seal 404 is axially compressed between the seal groove 444 and sealing surface 464 so as to create a fluid-tight seal between filter cap 402 and filter housing 410 as shown in FIG. 32. In other presently contemplated configurations, filter seal 404 can be arranged so as to form a fluid-tight radial seal between the filter cap 402 and filter housing 410. At the same time, the rotatable engagement of filter cap 402 and filter housing 410 causes engagement of the cap engagement members 445 and the housing engagement members 468. In one presently preferred representative embodiment, cap engagement members 445 can be angled so as to allow the cap engagement members 445 to engage with the housing engagement members 468 to provide for rotation in a single direction while engagement of the cap engagement members 445 and housing engagement members 468 comprise a locking configuration in the opposite, rotatable direction. As such, filter cap 402 can be retainably, substantially permanently joined to the filter housing 410 by allowing a ratcheting style engagement of the cap engagement members 445 and housing engagement members 468 as the filter cap 402 and filter housing 410 are rotatably attached and creating a locking arrangement of the cap engagement members 445 and housing engagement members 468 in a reverse direction in which filter cap 402 and filter housing 410 would be rotatably separated. The locking configuration strength defined between the cap engagement members 445 and housing engagement members 468 can be potentially infinitely, selectively configured by varying the size, shape, number and spacing of the cap engagement members 445 and housing engagement members 468. In one presently preferred embodiment, the rotatable direction for threadably attaching the filter cap 402 with the filter housing 410 corresponds to a rotatably, removable direction for removing cartridge filter 400 from a manifold assembly.

The embodiments shown in FIGS. 21-32 have a housing-male cap-female engagement configuration. This configuration can be reversed through the design of the housing with an enlarged open end and the cap with an indented attachment end such that a male cap can engage a female housing with the threads correspondingly reversed with respect to the inner versus outer surfaces.

Also, the locking structure is formed from the interface of cap engagement members 445 with housing engagement members 468. The configuration of the cap and housing engagement members can be reversed such as reversing the location of projecting members and receiving members with respect to the cap and housing. Similarly, the configurations of cap and housing engagement members can comprise a mixture of projecting members and receiving members located on both the cap and housing. Furthermore, the number of cap engagement members 445 housing engagement members can be selected to provide desired mechanical strength and design features with the number ranging from one to a large number and all numbers between and in which, for example, the numbers of cap engagement members 445 may not necessarily being the same as the number of housing engagement members 468. In some embodiments, a single cap engagement member 445 and housing engagement member 468 are respectively cylindrically symmetric and engagement of the members resists axial movement of the cap and housing to disconnect the cap from the housing. Also, the position of the cap engagement members 445 and housing engagement members 468 can be moved as long as the elements engage each other to lock cartridge filter 400 when the threads are appropriately engaged.

While the advantages of the various embodiments of the present disclosure have been disclosed, one skilled in the art will recognize that these embodiments are readily combinable and numerous freeze resistant embodiments are achievable.

1. A cartridge filter with a locking, threaded assembly comprising:
a filter housing comprising a housing thread and a housing engagement member;
a filter cap comprising a cap thread and a cap engagement member, wherein the filter cap and filter housing are rotatably, threadably connected with the cap thread and the housing thread; and
a filter element sealed within the cartridge filter,
wherein the housing engagement member and the cap engagement member engage each other to resist rotational detachment of the filter cap and the filter housing.

2. The cartridge filter of claim 1 further comprising a cartridge seal wherein the cartridge seal is compressed during threadable connection of the filter housing and the filter cap so as to create a fluid-tight seal.

3. The cartridge filter of claim 1 wherein the filter housing comprises an increased elasticity polyolefin polymer, wherein the increased elasticity polyolefin polymer has an ultimate elongation percentage exceeding about 100 percent.

4. The cartridge filter of claim 3 wherein the increased elasticity polyolefin polymer has an ultimate elongation percentage exceeding about 700 percent.

5. The cartridge filter of claim 3 wherein the increased elasticity polyolefin polymer is selected from the group comprising: a metallocene-plastomer modified polyethylene, a metallocene-plastomer modified polypropylene, a low density polyethylene, a high density polyethylene, a bimodal polyethy-lene and poly(ethylene-co-propylene).

6. The cartridge filter of claim 3 wherein the increased elasticity polyolefin polymer is Dowlex®.

7. The cartridge filter of claim 3 wherein the increased elasticity polyolefin polymer is Alathon®.

8. The cartridge filter of claim 1 wherein the filter cap is formed of a conventional, rigid polyolefin polymer.

9. The cartridge filter of claim 1 wherein the filter cap comprises a cap body and a manifold engagement member wherein the cap body is formed of an increased elasticity polyolefin polymer and the manifold engagement member is formed of a rigid polyolefin polymer.

10. The cartridge filter of claim 1 wherein the housing engagement members comprise:
angled tabs, grooves, ridges, bumps or cavities.

11. The cartridge filter of claim 1 wherein the cap engagement members comprise:
angled tabs, grooves, ridges, bumps or cavities.

12. The cartridge filter of claim 1 wherein the filter element comprises:
a depth filtration element, a surface filtration element, an activated carbon filtration element, a crossflow filtration element or a ceramic filtration element.

13. The cartridge filter of claim 1 wherein the filter housing comprises:
a plurality of housing engagement members.

14. The cartridge filter of claim 1 wherein the filter cap is substantially permanently sealed to the filter housing.

15. The cartridge filter of claim 1 wherein engaged housing engagement member and cap engagement member allow for tightening rotation of the threads.

16. A filtration assembly comprising:
a flow manifold operatively connected to the cartridge filter of claim 1.

17. A method of forming a cartridge filter with a locking, threaded assembly comprising:
attaching a filter cap to a filter housing to captively retain a filter element;
rotating the filter cap relative to the filter housing, the filter cap having a cap thread for rotatably engaging a housing thread on the filter housing wherein a cap engagement member on the filter cap engages with a housing engagement member on the filter housing as a result of rotatable attachment of the filter cap and the filter housing; and
lockingly engaging the cap engagement member with the housing engagement member to prevent detachment of the filter cap and the filter housing.

18. The method of claim 17 further comprising:
compressing a seal member to form a fluid-tight seal between the filter cap and the filter housing, the seal member being compressed during rotatable attachment of the filter cap and the filter housing.

19. The method of claim 17 wherein a plurality of engagement members on the filter cap engage a plurality of engagement members on the filter housing.

20. The method of claim 17 wherein the cap thread comprises a female thread and the housing thread comprises a male thread.
